(19) United States
(12) Patent Application Publication
(10) Pub. No.: US 2024/0316976 A1
(43) Pub. Date: Sep. 26, 2024

(54) THERMAL TRANSFER SHEET, METHOD FOR PRODUCING IMAGE-PRINTED MATERIAL, AND IMAGE-PRINTED MATERIAL

(71) Applicant: DAI NIPPON PRINTING CO., LTD., Tokyo (JP)

(72) Inventors: Yusuke NARUMI, Tokyo (JP); Yanhui LI, Tokyo (JP); Yoshihiro IMAKURA, Tokyo (JP); Akane FUKUDA, Tokyo (JP)

(73) Assignee: DAI NIPPON PRINTING CO., LTD., Tokyo (JP)

(21) Appl. No.: 18/578,062

(22) PCT Filed: Jul. 20, 2022
(86) PCT No.: PCT/JP2022/028261

§ 371 Date: Jan. 10, 2024

(30) Foreign Application Priority Data
Jul. 20, 2021 (JP) 2021-119975
Dec. 27, 2021 (JP) 2021-213450

(51) Int. Cl. B41M 5/44; B41M 5/395

(52) U.S. Cl. CPC B41M 5/44; B41M 5/395; B41M 2205/06; B41M 2205/38

(57) ABSTRACT

A thermal transfer sheet includes a substrate and a transfer layer on the substrate. The transfer layer includes an adhesive layer. The adhesive layer forms one surface layer of the thermal transfer sheet, and the adhesive layer contains an allyl resin and a modified olefin polymer.

### TECHNICAL FIELD

The present disclosure relates to a thermal transfer sheet, a method for producing an image-printed material, and an image-printed material.

### BACKGROUND ART

A thermofusible transfer system has been known in the related art. This system involves, for example, applying energy to a thermal transfer sheet including a substrate and a transfer layer by using a thermal head or other means to transfer the transfer layer onto a transfer target, such as a paper substrate or a resin film, and thus to form an image.

Images formed by the thermofusible transfer system have high density and sharpness. This system is thus suitable for recording binary images, such as characters and line drawings. The thermofusible transfer system enables recording of variable information, such as addresses, customer information, numbers, and barcodes, on a transfer target by using a computer and a thermal transfer printer (e.g., see PTL 1).

### CITATION LIST

### Patent Literature

PTL 1: Japanese Unexamined Patent Application Publication No. 2017-052278

### SUMMARY OF INVENTION

### Technical Problem

A known thermal transfer sheet includes an adhesive layer as a surface layer forming a transfer layer to improve close contact of the transfer layer with a transfer target. Use of a (meth)acrylic resin as a resin material of the adhesive layer is known to improve the resolution of images formed by using the thermofusible transfer system. However, the inventors of the present disclosure have found that images formed by using such a thermal transfer sheet have low scratch resistance and low alcohol resistance. To solve this issue, the inventors of the present disclosure have considered using polyester as a resin material for the adhesive layer. However, the inventors of the present disclosure have found that the use of polyester may degrade the resolution of images.

An object of the present disclosure is to provide a thermal transfer sheet that can form an image with high scratch resistance, high alcohol resistance, and high resolution. An object of the present disclosure is to provide a method for producing an image-printed material having an image with high scratch resistance, high alcohol resistance, and high resolution. An object of the present disclosure is to provide an image-printed material having an image with high scratch resistance, high alcohol resistance, and high resolution.

### Solution to Problem

A thermal transfer sheet of the present disclosure includes a substrate and a transfer layer on the substrate. The transfer layer includes an adhesive layer. The adhesive layer forms one surface layer of the thermal transfer sheet. The adhesive layer contains an allyl resin and a modified olefin polymer.

A method for producing an image-printed material of the present disclosure includes a step of preparing the thermal transfer sheet and a transfer target, and a step of thermally transferring the transfer layer of the thermal transfer sheet onto the transfer target.

An image-printed material of the present disclosure includes a transfer target and a transfer layer on the transfer target. The transfer layer includes an adhesive layer in direct contact with the transfer target. The adhesive layer contains an allyl resin and a modified olefin polymer.

### Advantageous Effects of Invention

The present disclosure can provide a thermal transfer sheet that can form an image with high scratch resistance, high alcohol resistance, and high resolution. The present disclosure can provide a method for producing an image-printed material having an image with high scratch resistance, high alcohol resistance, and high resolution. The present disclosure can provide an image-printed material having an image with high scratch resistance, high alcohol resistance, and high resolution.

### BRIEF DESCRIPTION OF DRAWINGS

FIG. 1 is a schematic cross-sectional view of an embodiment of the thermal transfer sheet of the present disclosure.

FIG. 2 is a schematic cross-sectional view of an embodiment of the thermal transfer sheet of the present disclosure.

FIG. 3 is a schematic cross-sectional view of an embodiment of the thermal transfer sheet of the present disclosure.

### DESCRIPTION OF EMBODIMENTS

Embodiments of the present disclosure will be described below in detail. The present disclosure can be implemented in many different forms and is not construed as being limited to the description of the following exemplary embodiments. For clear description, the width, thickness, shape, or other features of each layer may be illustrated more schematically in the drawings than in the embodiments. However, the drawings are merely examples and do not limit the interpretation of the present disclosure. In this description and each of the drawings, elements similar to those already described in relation to the illustrated drawings may be assigned with the same reference characters, and detailed description may be omitted as appropriate.

When two or more candidates of the upper limit and two or more candidates of the lower limit are listed for a certain parameter in the present disclosure, the numerical range of the parameter may be defined by a combination of any one of the candidates of the upper limit and any one of the candidates of the lower limit. In an example, the expression “The parameter B is preferably A1 or more, more preferably A2 or more, still more preferably A3 or more. The parameter B is preferably A4 or less, more preferably A5 or less, still more preferably A6 or less.” will be described. In this example, the numerical range of the parameter B may be A1 or more and A4 or less, A1 or more and A5 or less, A1 or more and A6 or less, A2 or more and A4 or less, A2 or more and A5 or less, A2 or more and A6 or less, A3 or more and A4 or less, A3 or more and A5 or less, or A3 or more and A6 or less.

### [Thermal Transfer Sheet]

A thermal transfer sheet of the present disclosure includes a substrate and a transfer layer on the substrate. The transfer layer includes an adhesive layer. The adhesive layer forms one surface layer of the thermal transfer sheet. The transfer layer may further include a colorant layer. The transfer layer may further include a release layer.

An embodiment of the thermal transfer sheet of the present disclosure will be described with reference to the drawings.

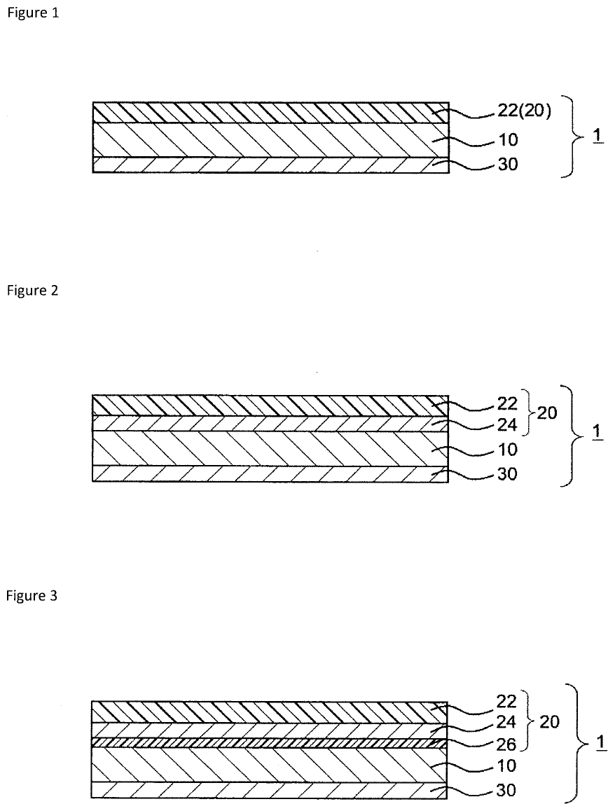

A thermal transfer sheet 1 illustrated in FIG. 1 includes a substrate 10 and a transfer layer 20. The transfer layer 20 is composed of an adhesive layer 22. The adhesive layer 22 forms one surface layer of the thermal transfer sheet 1.

A thermal transfer sheet 1 illustrated in FIG. 2 includes a substrate 10 and a transfer layer 20. The transfer layer 20 includes a colorant layer 24 and the adhesive layer 22 in this order in the thickness direction. The adhesive layer 22 forms a surface layer of the transfer layer 20 opposite the substrate 10.

A transfer layer 20 of a thermal transfer sheet 1 illustrated in FIG. 3 further includes a release layer 26.

The release layer 26 forms a surface layer of the transfer layer 20 adjacent to the substrate 10. The transfer layer 20 includes the release layer 26, the colorant layer 24, and the adhesive layer 22 in this order in the thickness direction.

The thermal transfer sheets 1 illustrated in FIG. 1 to FIG. 3 each include a backing layer 30 on a surface of the substrate 10 opposite the surface on which the transfer layer 20 is provided.

Each layer of the thermal transfer sheet of the present disclosure will be described below.

### <Substrate>

The substrate can be used without limitation as long as the substrate has heat resistance sufficient to withstand the thermal energy applied during thermal transfer and has solvent resistance and mechanical strength sufficient to support the transfer layer and other layers on the substrate.

Examples of the substrate include a film made of a resin material (hereinafter referred to as a “resin film”). Examples of the resin material include polyesters, polyolefins, vinyl resins, vinyl acetal resins, (meth)acrylic resins, polyamides, polyimides, polycarbonates, cellulose resins, styrene resins, and ionomer resins. Examples of polyesters include polyethylene terephthalate (PET), polybutylene terephthalate (PBT), polyethylene naphthalate (PEN), poly-1,4-cyclohexylene dimethylene terephthalate, and terephthalic acid-cyclohexanedimethanol-ethylene glycol copolymer. Examples of polyolefins include polyethylene (PE), polypropylene (PP), and polymethylpentene. Examples of vinyl resins include polyvinyl chloride, polyvinyl alcohol (PVA), polyvinyl acetate, vinyl chloride-vinyl acetate copolymer, and polyvinylpyrrolidone (PVP). Examples of vinyl acetal resins include polyvinyl acetoacetal and polyvinyl butyral. Examples of (meth)acrylic resins include polyacrylate, polymethacrylate, and polymethylmethacrylate. Examples of cellulose resins include cellophane, cellulose acetate, nitrocellulose, cellulose acetate propionate (CAP), and cellulose acetate butyrate (CAB). Examples of styrene resins include polystyrene (PS). The resin materials can be used singly or in combination of two or more.

Of the resin materials described above, polyesters, such as PET and PEN, are preferred, and PET is more preferred, from the viewpoint of high heat resistance and high mechanical strength.

In the present disclosure, the term “(meth)acrylic” encompasses both “acrylic” and “methacrylic.” The term “(meth)acrylate” encompasses both “acrylate” and “methacrylate.”

A laminate of the resin films may be used as a substrate. The laminate of the resin films can be produced by, for example, using dry lamination, wet lamination, or extrusion.

When the substrate is a resin film, the resin film may be an oriented film or an unoriented film. From the viewpoint of high strength, the substrate is preferably a uniaxially or biaxially oriented film.

The substrate preferably has a thickness of 3.0 μm or more. The substrate preferably has a thickness of 25.0 μm or less.

### <Transfer Layer>

The thermal transfer sheet of the present disclosure includes a transfer layer on the substrate. The transfer layer is releasably attached to the substrate by thermal transfer. The transfer layer includes an adhesive layer. The transfer layer may further include a colorant layer. The transfer layer may further include a release layer. The adhesive layer forms one surface layer of the thermal transfer sheet. When the transfer layer has a multilayer structure, the adhesive layer forms a surface layer of the transfer layer opposite the substrate. The adhesive layer is a layer to come into contact with a transfer target when the transfer layer is transferred onto the transfer target. The release layer forms a surface layer of the transfer layer adjacent to the substrate.

### (Adhesive Layer)

The adhesive layer contains an allyl resin and a modified olefin polymer.

When the adhesive layer contains an allyl resin and a modified olefin polymer, the durability (specifically, scratch resistance and alcohol resistance) of images formed on the transfer target can be improved while maintaining the resolution of the images.

Polyethylene terephthalate (PET) and polypropylene (PP) are often used as the material of the transfer target. These materials significantly differ in solubility parameter (SP value), and it has been difficult to form images with high quality on both of transfer targets of these materials by using one thermal transfer sheet. The use of the thermal transfer sheet of the present disclosure can form images with high scratch resistance and high alcohol resistance on both of a transfer target made of PET (hereinafter also referred to as a “PET transfer target”) and a transfer target made of PP (hereinafter also referred to as a “PP transfer target”).

The allyl resin refers to a resin having a structural unit derived from an allyl monomer. Examples of the allyl monomer include diallyl phthalate, triallyl isocyanurate, diallyl tetrabromphthalate, allyl glycidyl ether, trimethylolpropane diallyl ether, pentaerythritol triallyl ether, triallyl trimellitate, tetraallyl pyromellitate, allyl sorbate, diallyl maleate, diallyl fumarate, diallyl citrate, and tetraallyl butanetetracarboxylate. Of these allyl monomers, diallyl phthalate is preferred to further improve the above advantageous effect.

The allyl resin may have a structural unit derived from a compound (copolymer component) other than an allyl monomer. The content ratio of the structural unit derived from the copolymer component in the allyl resin is preferably 10 mass % or less, more preferably 5 mass % or less, still more preferably 3 mass % or less.

From the viewpoint of the plasticizer resistance of the transfer layer, the iodine value of the allyl resin is preferably 40 g/100 g or more, more preferably 45 g/100 g or more, preferably 95 g/100 g or less, more preferably 70 g/100 g or less. The iodine value is measured in accordance with JIS K 6235:2006.

In one embodiment, the allyl resin is a diallyl phthalate resin. The diallyl phthalate resin refers to a resin having a structural unit derived from diallyl phthalate. The diallyl phthalate resin may be hydrogenated. The diallyl phthalate resin is not limited to an ortho-form and encompasses, for example, an iso-form.

The diallyl phthalate resin is preferably, for example, any one or two or more of the resins represented by formulas (1) to (4). The presence of the diallyl phthalate resin having such a structure in the adhesive layer can improve, for example, the above advantageous effect. In consideration of durability and plasticizer resistance, the resin represented by formula (1) or (3) is more preferred, and the resin represented by formula (1) is still more preferred.

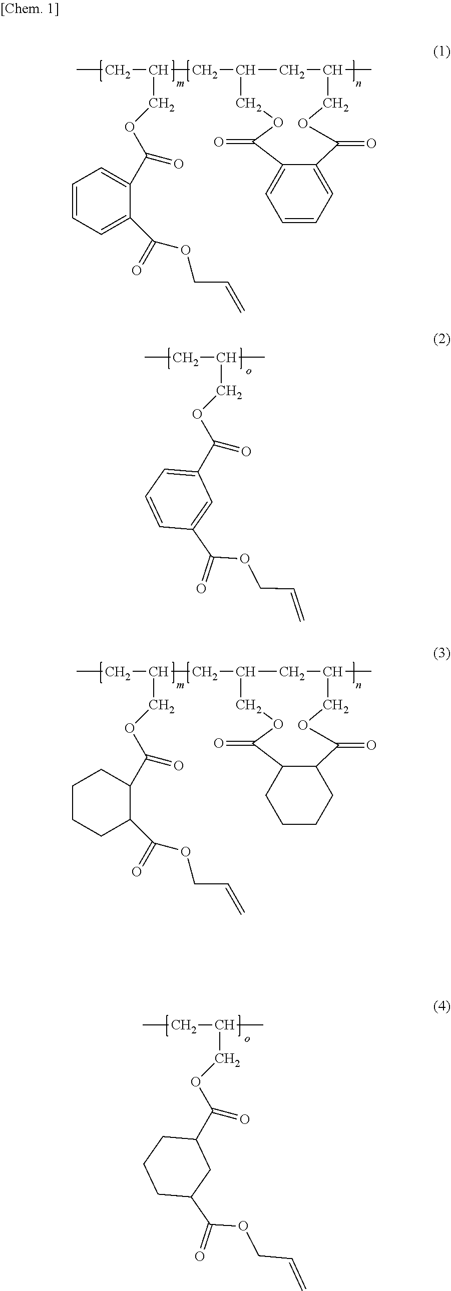

In formulas (1) to (4), m, n, and o each represent an integer greater than or equal to 1, and represent, for example, a value such that the molecular weight of the resin represented by each formula is the weight-average molecular weight described below.

For example, DAISO DAP (registered trademark) A, DAISO DAP (registered trademark) S, and DAISO DAP (registered trademark) K available from Osaka Soda Co., Ltd. can be used as the allyl resin represented by formula (1). For example, DAISO DAP available from Osaka Soda Co., Ltd. can be used as the allyl resin represented by formula (2). For example, RADPAR (registered trademark) AD-032 available from Osaka Soda Co., Ltd. can be used as the allyl resin represented by formula (3).

The weight-average molecular weight (Mw) of the allyl resin is preferably 5,000 or more, more preferably 10,000 or more. The Mw of the allyl resin is preferably 100,000 or less, more preferably 70,000 or less. The Mw in the present disclosure means a value measured by gel permeation chromatography using polystyrene as a standard substance in accordance with JIS K 7252-1:2016.

The allyl resin can be cured by irradiation with active energy rays, such as ultraviolet rays, or can be cured with heat in combination with a polymerization initiator, such as a peroxide. In the present disclosure, the allyl resin is preferably uncured.

The softening temperature of the allyl resin is preferably 55° C. or higher, more preferably 60° C. or higher. The softening temperature of the allyl resin is preferably 120° C. or lower, more preferably 115° C. or lower. The allyl resin with such a softening temperature can improve, for example, transferability to transfer targets and the durability of formed images. The softening temperature in the present disclosure is measured by a method in accordance with the ring-and-ball method in JIS K 2207:2006.

The allyl resins can be used singly or in combination of two or more.

The adhesive layer contains a modified olefin polymer.

Examples of the modified olefin polymer include acid-modified products of olefin polymers (acid-modified olefin polymers), chlorinated products of olefin polymers (chlorinated olefin polymers), and acid-modified chlorinated products of olefin polymers (acid-modified chlorinated olefin polymers).

Examples of acid-modified products of olefin polymers include not only olefin polymers graft-modified with at least one selected from unsaturated carboxylic acids and their derivatives, but also copolymers of α-olefins and at least one selected from unsaturated carboxylic acids and their derivatives. In other words, in acid-modified olefin polymers and acid-modified chlorinated olefin polymers, the structural unit derived from an unsaturated carboxylic acid and/or its derivative may be included in the polymer side chains in a graft-modified form, or may be included in the polymer main chain in a copolymer form.

Examples of the olefin polymer include homopolymers of α-olefins, copolymers of two or more α-olefins, and copolymers of α-olefins and other non-polar monomers. Examples of the copolymer form include random copolymers and block copolymers.

Examples of the α-olefins include ethylene, propylene, 1-butene, 4-methyl-1-pentene, 3-methyl-1-butene, 1-hexene, 1-octene, and 1-decene. The number of carbon atoms in the α-olefins is preferably 2 or more. The number of carbon atoms in the α-olefins is preferably 20 or less, more preferably 10 or less. The α-olefins are preferably ethylene and propylene. The α-olefins can be used singly or in combination of two or more.

Examples of the non-polar monomers other than α-olefins include styrenic monomers, such as styrene, conjugated dienes, such as butadiene, and cyclic olefins, such as norbornene. The copolymers described above may include a structural unit derived from a non-polar monomer other than α-olefins in a range of preferably 30 mass % or less, more preferably 20 mass % or less, still more preferably 10 mass % or less. In the present disclosure, the content ratio of each structural unit is measured by nuclear magnetic resonance (NMR). The non-polar monomers can be used singly or in combination of two or more.

Specific examples of the olefin polymer include polyethylene, polypropylene, polybutene, and poly-4-methyl-1-pentene. In the present disclosure, polyethylene is not limited to an ethylene homopolymer and encompasses, for example, copolymers of ethylene with other monomers. The same applies to polypropylene and other olefin polymers.

Examples of the unsaturated carboxylic acid include (meth)acrylic acid, maleic acid, fumaric acid, tetrahydrophthalic acid, itaconic acid, citraconic acid, crotonic acid, isocrotonic acid, norbornenedicarboxylic acid, and bicyclo[2.2.1]hept-2-ene-5,6-dicarboxylic acid. Of these unsaturated carboxylic acids, maleic acid is preferred. The unsaturated carboxylic acids can be used singly or in combination of two or more.

Examples of the unsaturated carboxylic acid derivative include acid anhydrides, acid halides, amides, imides, esters, or salts of unsaturated carboxylic acids. Examples of the unsaturated carboxylic acid derivative include maleic anhydride, itaconic anhydride, citraconic anhydride, tetrahydrophthalic anhydride, bicyclo[2.2.1]hept-2-ene-5,6-dicarboxylic anhydride, maleyl chloride, acrylamide, methacrylamide, malenylimide, dimethyl maleate, monomethyl maleate, diethyl maleate, monoethyl maleate, diethyl fumarate, dimethyl itaconate, diethyl citraconate, dimethyl tetrahydrophthalate, dimethyl bicyclo[2.2.1]hept-2-ene-5,6-dicarboxylate, alkyl (meth)acrylate, hydroxyethyl (meth)acrylate, hydroxypropyl (meth)acrylate, glycidyl (meth)acrylate, and ammonium salts or amine salts of unsaturated carboxylic acids. Of these unsaturated carboxylic acid derivatives, acid anhydrides of unsaturated carboxylic acids are preferred, and maleic anhydrides of unsaturated carboxylic acids are more preferred. The unsaturated carboxylic acid derivatives can be used singly or in combination of two or more.

Of acid-modified olefin polymers, acid-modified polyethylene and acid-modified polypropylene are preferred, acid-modified polypropylene is more preferred, and maleic acid-modified polypropylene and maleic anhydride-modified polypropylene are still more preferred. Of acid-modified chlorinated olefin polymers, acid-modified chlorinated polyethylene and acid-modified chlorinated polypropylene are preferred, acid-modified chlorinated polypropylene is more preferred, and maleic acid-modified chlorinated polypropylene and maleic anhydride-modified chlorinated polypropylene are still more preferred.

In the acid-modified olefin polymer and the acid-modified chlorinated olefin polymer, the total content ratio of the structural units derived from an unsaturated carboxylic acid and its derivative is preferably 0.01 mass % or more, more preferably 0.1 mass % or more. The total content ratio is preferably 25 mass % or less, more preferably 10 mass % or less, still more preferably 5 mass % or less.

Of modified olefin polymers, chlorinated olefin polymers and acid-modified chlorinated olefin polymers are preferred, and acid-modified chlorinated olefin polymers are more preferred, from the viewpoint of the image formability on PET transfer targets and PP transfer targets.

The chlorination degree of the chlorinated olefin polymer and the acid-modified chlorinated olefin polymer is preferably 10 mass % or more, more preferably 15 mass % or more. The chlorination degree of the chlorinated olefin polymer and the acid-modified chlorinated olefin polymer is preferably 50 mass % or less, more preferably 30 mass % or less. With this chlorination degree, the image formability of the thermal transfer sheet on PET transfer targets and PP transfer targets can be improved. The chlorination degree in the present disclosure is measured in accordance with the determination of chlorine in chlorine-containing polymers in JIS K 7229:1995.

The number-average molecular weight (Mn) of the modified olefin polymer is preferably 5,000 or more, more preferably 10,000 or more, still more preferably 15,000 or more. The Mn of the modified olefin polymer is preferably 100,000 or less, more preferably 80,000 or less, still more preferably 70,000 or less. When the Mn is lower than or equal to the upper limit, for example, the transfer layer may have high image printing sensitivity. When the Mn is greater than or equal to the lower limit, for example, the adhesive layer may have high durability. The Mn in the present disclosure means a value measured by gel permeation chromatography using polystyrene as a standard substance in accordance with JIS K 7252-1:2016.

The modified olefin polymers can be used singly or in combination of two or more.

The content ratio of the allyl resin in the adhesive layer is preferably 10 mass % or more, more preferably 20 mass % or more, still more preferably 30 mass % or more. The content ratio of the allyl resin in the adhesive layer is preferably 95 mass % or less, more preferably 85 mass % or less. This configuration can improve, for example, the scratch resistance, alcohol resistance, and resolution of formed images.

The content ratio of the modified olefin polymer in the adhesive layer is preferably 5 mass % or more, more preferably 15 mass % or more. The content ratio of the modified olefin polymer in the adhesive layer is preferably 90 mass % or less, more preferably 80 mass % or less, still more preferably 70 mass % or less. This configuration can improve, for example, the scratch resistance, alcohol resistance, and resolution of formed images.

The content ratio of the allyl resin in the adhesive layer is preferably larger than the content ratio of the modified olefin polymer. This allows, for example, formation of images with higher scratch resistance, higher alcohol resistance, and higher resolution on transfer targets, such as PET transfer targets and PP transfer targets. For example, the content ratio of the allyl resin with respect to the total content of the allyl resin and the modified olefin polymer in the adhesive layer is preferably more than 50 mass %, more preferably 55 mass % or more, still more preferably 60 mass % or more, preferably 85 mass % or less, more preferably 80 mass % or less. For example, the content ratio of the modified olefin polymer with respect to the total content of the allyl resin and the modified olefin polymer in the adhesive layer is preferably 15 mass % or more, more preferably 20 mass % or more, preferably less than 50 mass %, more preferably 45 mass % or less, still more preferably 40 mass % or less.

The adhesive layer may contain one or two or more resin materials other than the allyl resin and the modified olefin polymer. Examples of such resin materials include vinyl resins, vinyl acetal resins, (meth)acrylic resins, styrene resins, polyesters, polyamides, polyimides, polycarbonates, cellulose resins, and ionomer resins. Examples of vinyl resins include ethylene-vinyl acetate copolymer resins, vinyl chloride-vinyl acetate copolymer resins, and vinyl acetate resins. Examples of (meth)acrylic resins include specific examples listed in the section of the colorant layer, and a styrene-(meth)acrylic copolymer resin. The adhesive layer may further contain, for example, at least one selected from an ethylene-vinyl acetate copolymer resin and a styrene-(meth)acrylic copolymer resin.

The adhesive layer may further contain an ethylene-vinyl acetate copolymer resin, in addition to the allyl resin and the modified olefin polymer. This configuration can improve, for example, the close contact of images with transfer targets, such as PET transfer targets and PP transfer targets.

The adhesive layer may further contain an ethylene-vinyl acetate copolymer resin and a styrene-(meth)acrylic copolymer resin, in addition to the allyl resin and the modified olefin polymer. This configuration can improve, for example, the resolution of formed images, and the close contact of the images with transfer targets, such as PET transfer targets and PP transfer targets.

The melt mass-flow rate (MFR) of the ethylene-vinyl acetate copolymer resin measured at a temperature of 190° C. and a load of 2.16 kg by the method A in accordance with JIS K 7210-1:2014 is preferably 0.1 g/10 min or more, more preferably 1 g/10 min or more, still more preferably 5 g/10 min or more. The MFR of the ethylene-vinyl acetate copolymer resin is preferably 50 g/10 min or less, more preferably 30 g/10 min or less, still more preferably 25 g/10 min or less.

The ethylene-vinyl acetate copolymer resin has a structural unit derived from ethylene and a structural unit (vinyl acetate unit) derived from vinyl acetate.

The content of the vinyl acetate unit (vinyl acetate content) of the ethylene-vinyl acetate copolymer resin measured in accordance with JIS K 7192:1999 is preferably 5 mass % or more, more preferably 10 mass % or more, still more preferably 15 mass % or more. The vinyl acetate content in the ethylene-vinyl acetate copolymer resin is preferably 50 mass % or less, more preferably 45 mass % or less, still more preferably 40 mass % or less.

The MFR of the styrene-(meth)acrylic copolymer resin measured at a temperature of 200° C. and a load of 5 kg by the method A in accordance with JIS K 7210-1:2014 is preferably 0.1 g/10 min or more, more preferably 0.2 g/10 min or more, still more preferably 0.5 g/10 min or more. The MFR of the styrene-(meth)acrylic copolymer resin is preferably 30 g/10 min or less, more preferably 10 g/10 min or less, still more preferably 5 g/10 min or less.

The styrene-(meth)acrylic copolymer resin has a structural unit derived from ethylene and a structural unit derived from (meth)acrylic acid or a (meth)acrylic acid ester. The styrene-(meth)acrylic copolymer resin may have a structural unit derived from (meth)acrylic acid and a structural unit derived from a (meth)acrylic acid ester. Examples of the (meth)acrylic acid ester include specific examples listed below in the section of the colorant layer.

The content of the ethylene-vinyl acetate copolymer resin in the adhesive layer with respect to the total content (100 parts by mass) of the allyl resin and the modified olefin polymer is preferably 1 part by mass or more, more preferably 5 parts by mass or more, still more preferably 15 parts by mass or more, preferably 35 parts by mass or less, more preferably 30 parts by mass or less, still more preferably 25 parts by mass or less. This configuration can improve, for example, the close contact of images with transfer targets, such as PET transfer targets and PP transfer targets.

The content of the styrene-(meth)acrylic copolymer resin in the adhesive layer with respect to the total content (100 parts by mass) of the allyl resin and the modified olefin polymer is preferably 1 part by mass or more, more preferably 5 parts by mass or more, still more preferably 15 parts by mass or more, preferably 35 parts by mass or less, more preferably 30 parts by mass or less, still more preferably 25 parts by mass or less. This configuration can improve, for example, the blocking resistance of the thermal transfer sheet.

The adhesive layer may contain one or two or more additives. Examples of the additives include fillers, plasticizers, antistatic agents, ultraviolet absorbers, inorganic particles, organic particles, colorants, release agents, and dispersants.

The thickness of the adhesive layer is preferably 0.1 μm or more, more preferably 0.15 μm or more, still more preferably 0.2 μm or more. The thickness of the adhesive layer is preferably 10.0 μm or less, more preferably 8.0 μm or less, still more preferably 5.0 μm or less. The adhesive layer with such a thickness can improve, for example, the image printability of the thermal transfer sheet on transfer targets.

The adhesive layer can be formed by, for example, dispersing or dissolving the above materials in water or a suitable organic solvent to prepare a coating liquid, applying the coating liquid to a target object to form a coating, and drying the coating. Examples of known coating methods include roll coating, reverse roll coating, gravure coating, reverse gravure coating, bar coating, and rod coating.

### (Colorant Layer)

In one embodiment, the transfer layer may further include a colorant layer.

The colorant layer contains a colorant and, in one embodiment, further contains a resin material.

The colorant may be a pigment or a dye. Examples of the colorant include red colorants, yellow colorants, blue colorants, green colorants, black colorants, white colorants, metallic pigments, and pearl pigments. Examples of red colorants include cadmium red, cadmopone red, chrome red, vermilion, bengala, azo pigments, alizarin lake, quinacridone, and cochineal lake perylene. Examples of yellow colorants include yellow ocher, aureolin, cadmium yellow, cadmium orange, chrome yellow, zinc yellow, Naples yellow, nickel yellow, azo pigments, and greenish yellow. Examples of bule colorants include ultramarine, iwagunjo, cobalt, phthalocyanine, anthraquinone, and indigoids. Examples of green colorants include cinnabar green, cadmium green, chrome green, phthalocyanine, azomethine, and perylene. Examples of black colorants include carbon black. Examples of white colorants include silica, calcium carbonate, and titanium oxide. Examples of metallic pigments include aluminum, nickel, chromium, brass, tin, brass, bronze, zinc, silver, platinum, gold, and oxides thereof, and metal-deposited glass. Examples of pearl pigments include pigments prepared by coating alumina pigments and mica pigments with oxides of metals, such as titanium, iron, zirconium, silicon, aluminum, and cerium.

The colorants can be used singly or in combination of two or more.

The content ratio of the colorant in the colorant layer is preferably 10 mass % or more. The content ratio of the colorant in the colorant layer is preferably 60 mass % or less.

Examples of the resin material include allyl resins, polyolefins, vinyl resins, (meth)acrylic resins, styrene resins, polyesters, polyamides, polyimides, polycarbonates, cellulose resins, and ionomer resins. Examples of vinyl resins include ethylene-vinyl acetate copolymer resins, vinyl chloride-vinyl acetate copolymer resins, vinyl chloride resins, and vinyl acetate resins. Of these vinyl resins, allyl resins, vinyl chloride-vinyl acetate copolymer resins, (meth)acrylic resins, and polyesters are preferred. To improve the resolution of formed images, allyl resins are more preferred, and diallyl phthalate resin is still more preferred. To improve the blocking resistance of the thermal transfer sheet, vinyl chloride-vinyl acetate copolymer resins and (meth)acrylic resins are preferred.

The details of the allyl resin are as described above. When an allyl resin is used as the resin material of the colorant layer, the allyl resin of the colorant layer may be the same as or different from the allyl resin of the adhesive layer.

The allyl resins can be used singly or in combination of two or more.

The weight-average molecular weight (Mw) of the allyl resin is preferably 5,000 or more, more preferably 10,000 or more. The Mw of the allyl resin is preferably 100,000 or less, more preferably 70,000 or less, still more preferably 50,000 or less, yet still more preferably 40,000 or less. When the Mw is 50,000 or less, for example, the formed images may have higher resolution.

The number-average molecular weight (Mn) of a vinyl chloride-vinyl acetate copolymer resin is preferably 5,000 or more, more preferably 10,000 or more. The Mn of the vinyl chloride-vinyl acetate copolymer resins is preferably 80,000 or less, more preferably 60,000 or less, still more preferably 50,000 or less.

The content of the vinyl acetate unit (vinyl acetate content) in the vinyl chloride-vinyl acetate copolymer resin is preferably 1 mass % or more, more preferably 5 mass % or more. The vinyl acetate content in the vinyl chloride-vinyl acetate copolymer resin is preferably 30 mass % or less, more preferably 20 mass % or less.

To maintain stability in a product form, the glass transition temperature (Tg) of the vinyl chloride-vinyl acetate copolymer resin is preferably 40° C. or higher, more preferably 50° C. or higher. The Tg of the vinyl chloride-vinyl acetate copolymer resin is preferably 95° C. or lower, more preferably 85° C. or lower.

The weight-average molecular weight (Mw) of the (meth)acrylic resin is preferably 5,000 or more, more preferably 10,000 or more. The Mw of the (meth)acrylic resin is preferably 80,000 or less, more preferably 60,000 or less, still more preferably 50,000 or less.

To maintain stability in a product form, the glass transition temperature (Tg) of the (meth)acrylic resin is preferably 50° C. or higher, more preferably 60° C. or higher. The Tg of the (meth)acrylic resin is preferably 130° C. or lower, more preferably 120° C. or lower.

Examples of the (meth)acrylic resin include polymers of (meth)acrylic acid or their derivatives, polymers of (meth)acrylic esters or their derivatives, copolymers of (meth)acrylic acid with other monomers or their derivatives, and copolymers of (meth)acrylic esters with other monomers or their derivatives.

Examples of (meth)acrylic esters include alkyl (meth)acrylates, hydroxyalkyl (meth)acrylates, and cyclic skeleton-containing (meth)acrylates. Examples of other monomers include styrene, vinyl chloride, and (meth)acrylamide. Examples of alkyl (meth)acrylates include methyl (meth)acrylate, ethyl (meth)acrylate, propyl (meth)acrylate, butyl (meth)acrylate, and lauryl (meth)acrylate. Examples of hydroxyalkyl (meth)acrylates include 2-hydroxyethyl (meth)acrylate, and 2-hydroxypropyl (meth)acrylate. Examples of cyclic skeleton-containing (meth)acrylates include cycloalkyl (meth)acrylate, isobornyl (meth)acrylate, dicyclopentanyl (meth)acrylate, phenyl (meth)acrylate, and benzyl (meth)acrylate.

Specific examples of (meth)acrylic resins include polymethyl (meth)acrylate, polyethyl (meth)acrylate, polypropyl (meth)acrylate, polybutyl (meth)acrylate, methyl (meth)acrylate-butyl (meth)acrylate copolymer, ethyl (meth)acrylate-butyl (meth)acrylate copolymer, and styrene-methyl (meth)acrylate copolymer.

A polyester means a copolymer of a dicarboxylic acid compound with a diol compound.

Examples of the dicarboxylic acid compound include malonic acid, succinic acid, glutaric acid, adipic acid, suberic acid, sebacic acid, dodecanedioic acid, eicosandioic acid, pimelic acid, azelaic acid, methylmalonic acid, ethylmalonic acid, adamantanedicarboxylic acid, norbornenedicarboxylic acid, cyclohexanedicarboxylic acid, decalindicarboxylic acid, terephthalic acid, isophthalic acid, phthalic acid, 1,4-naphthalenedicarboxylic acid, 1,5-naphthalenedicarboxylic acid, 2,6-naphthalenedicarboxylic acid, 1,8-naphthalenedicarboxylic acid, 4,4′-diphenyldicarboxylic acid, 4,4′-diphenyl ether dicarboxylic acid, 5-sodium sulfoisophthalic acid, phenylendan dicarboxylic acid, anthracene dicarboxylic acid, phenanthrene dicarboxylic acid, 9,9′-bis(4-carboxyphenyl)fluorenic acid, and their ester derivatives. The dicarboxylic acid compounds can be used singly or in combination of two or more.

Examples of the diol compound include ethylene glycol, 1,2-propanediol, 1,3-propanediol, butanediol, 2-methyl-1,3-propanediol, hexanediol, neopentyl glycol, cyclohexane dimethanol, cyclohexane diethanol, decahydronaphthalene dimethanol, decahydronaphthalene diethanol, norbornane dimethanol, norbornane diethanol, tricyclodecane dimethanol, tricyclodecane ethanol, tetracyclododecane dimethanol, tetracyclododecane diethanol, decalin dimethanol, decalin diethanol, 5-methylol-5-ethyl-2-(1,1-dimethyl-2-hydroxyethyl)-1,3-dioxane, cyclohexanediol, bicyclohexyl-4,4′-diol, 2,2-bis(4-hydroxycyclohexylpropane), 2,2-bis(4-(2-hydroxyethoxy)cyclohexyl)propane, cyclopentanediol, 3-methyl-1,2-cyclopentadiol, 4-cyclopentene-1,3-diol, adamandiol, paraxylene glycol, bisphenol A, bisphenol S, styrene glycol, trimethylolpropane, and pentaerythritol. The diol compounds can be used singly or in combination of two or more.

The polyester may have a structural unit derived from a compound (other compound) other than the dicarboxylic acid compound and the diol compound. The content ratio of the structural unit derived from the other compound in the polyester is preferably 10 mass % or less, more preferably 5 mass % or less, still more preferably 3 mass % or less.

The polyesters can be used singly or in combination of two or more.

From the viewpoint of the durability of the transfer layer, the number-average molecular weight (Mn) of the polyester is preferably 2,000 or more, more preferably 3,000 or more, still more preferably 4,000 or more. The Mn of the polyester is preferably 20,000 or less, more preferably 15,000 or less, still more preferably 12,000 or less. The Mn in the present disclosure means a value measured by gel permeation chromatography using polystyrene as a standard substance in accordance with JIS K 7252-1:2016.

To maintain stability in a product form, the glass transition temperature (Tg) of the polyester is preferably 20° C. or higher, more preferably 50° C. or higher. The Tg of the polyester is preferably 90° C. or lower, more preferably 80° C. or lower. In the present disclosure, the Tg is determined by differential scanning calorimetry (DSC) in accordance with JIS K 7121:2012.

Amorphous polyester is preferred as the polyester.

The resin materials can be used singly or in combination of two or more.

The content ratio of the resin material in the colorant layer is preferably 40 mass % or more. The content ratio of the resin material in the colorant layer is preferably 90 mass % or less.

In one embodiment, the colorant layer may further contain an allyl resin as a resin material. The content ratio of the allyl resin in the resin material of the colorant layer is preferably 50 mass % or more, more preferably 70 mass % or more, still more preferably 80 mass % or more, 85 mass % or more, 90 mass % or more, or 95 mass % or more. This configuration can improve, for example, the resolution of formed images. The content ratio of the allyl resin in the resin material of the colorant layer is preferably 10 mass % or more, more preferably 20 mass % or more, still more preferably 30 mass % or more, yet still more preferably 40 mass % or more.

In one embodiment, the colorant layer may contain a vinyl chloride-vinyl acetate copolymer resin as a resin material. This resin material can improve, for example, the blocking resistance of the thermal transfer sheet. The content ratio of the vinyl chloride-vinyl acetate copolymer resin in the resin material of the colorant layer is preferably 10 mass % or more, more preferably 20 mass % or more, still more preferably 30 mass % or more, yet still more preferably 40 mass % or more. The content ratio of the vinyl chloride-vinyl acetate copolymer resin in the resin material of the colorant layer is preferably 90 mass % or less, more preferably 80 mass % or less, still more preferably 65 mass % or less, yet still more preferably 60 mass % or less. This configuration can improve, for example, the blocking resistance of the thermal transfer sheet and other physical properties, such as durability and resolution, of formed images in a well-balanced manner.

In one embodiment, the colorant layer may contain an allyl resin, such as a diallyl phthalate resin, and a vinyl chloride-vinyl acetate copolymer resin as resin materials. These resin materials can improve, for example, the scratch resistance, alcohol resistance, and resolution of formed images and the blocking resistance of the thermal transfer sheet in a well-balanced manner.

The content ratio of the allyl resin in the resin materials of the colorant layer containing the allyl resin and the vinyl chloride-vinyl acetate copolymer resin is preferably 10 mass % or more, more preferably 20 mass % or more, still more preferably 35 mass % or more, yet still more preferably 40 mass % or more, preferably 90 mass % or less, more preferably 80 mass % or less, still more preferably 70 mass % or less, yet still more preferably 60 mass % or less. This configuration can improve, for example, the scratch resistance, alcohol resistance, and resolution of formed images and the blocking resistance of the thermal transfer sheet in a well-balanced manner.

In one embodiment, in the thermal transfer sheet of the present disclosure, the adhesive layer contains an allyl resin, a modified olefin polymer, an ethylene-vinyl acetate copolymer resin, and an optional styrene-(meth)acrylic copolymer resin, and the colorant layer contains an allyl resin and a vinyl chloride-vinyl acetate copolymer resin. This configuration can improve, for example, the scratch resistance, alcohol resistance, and resolution of formed images and can achieve both the close contact of the images and the blocking resistance of the thermal transfer sheet.

In one embodiment, the colorant layer may contain a (meth)acrylic resin and a vinyl chloride-vinyl acetate copolymer resin as resin materials. These resin materials can improve, for example, the scratch resistance and alcohol resistance of formed images and the blocking resistance of the thermal transfer sheet in a well-balanced manner. The content ratio of the (meth)acrylic resin in the resin materials of the colorant layer containing the (meth)acrylic resin and the vinyl chloride-vinyl acetate copolymer resin is preferably 10 mass % or more, more preferably 20 mass % or more, still more preferably 30 mass % or more, yet still more preferably 40 mass % or more, preferably 90 mass % or less, more preferably 80 mass % or less, still more preferably 70 mass % or less, yet still more preferably 60 mass % or less.

The content ratio of the vinyl chloride-vinyl acetate copolymer resin in the resin materials of the colorant layer containing the (meth)acrylic resin and the vinyl chloride-vinyl acetate copolymer resin is preferably 10 mass % or more, more preferably 20 mass % or more, still more preferably 30 mass % or more, yet still more preferably 40 mass % or more, preferably 90 mass % or less, more preferably 80 mass % or less, still more preferably 70 mass % or less, yet still more preferably 60 mass % or less.

In one embodiment, in the thermal transfer sheet of the present disclosure, the adhesive layer contains an allyl resin, a modified olefin polymer, an ethylene-vinyl acetate copolymer resin, and an optional styrene-(meth)acrylic copolymer resin, and the colorant layer contains a (meth)acrylic resin and a vinyl chloride-vinyl acetate copolymer resin. This configuration can improve, for example, the scratch resistance, alcohol resistance, and resolution of formed images and can achieve both the close contact of the images and the blocking resistance of the thermal transfer sheet.

The colorant layer may contain one or two or more of the additives.

The thickness of the colorant layer is preferably 0.1 μm or more, more preferably 0.3 μm or more, from the viewpoint of the density of images formed on a transfer target. The thickness of the colorant layer is preferably 10.0 μm or less, more preferably 5.0 μm or less.

### (Release Layer)

In one embodiment, the transfer layer of the thermal transfer sheet may include a release layer as a layer closest to the substrate among the layers constituting the transfer layer. The release layer is a layer to be transferred together with the adhesive layer and the colorant layer during thermal transfer. The release layer can improve the transferability of the transfer layer. The release layer is transferred as part of the transfer layer during thermal transfer and, after transfer, forms a surface layer of a thermally transferred image to improve the scratch resistance of the thermally transferred image.

Examples of the components in the release layer include waxes and resin materials. Of these components, waxes are preferred to improve the releasability of the transfer layer during thermal transfer.

Examples of the waxes include natural waxes, synthetic waxes, higher saturated fatty acids, higher saturated monohydric alcohols, higher fatty acid esters, and higher fatty acid amides. Examples of natural waxes include beeswax, spermaceti, wood wax, rice bran wax, carnauba wax, candelilla wax, and montan wax. Examples of synthetic waxes include paraffin wax, microcrystalline wax, silicone wax, oxidized wax, ozokerite, ceresin, ester wax, and polyethylene wax. Examples of higher saturated fatty acids include margaric acid, lauric acid, myristic acid, palmitic acid, stearic acid, furoic acid, and behenic acid. Examples of higher saturated monohydric alcohols include stearyl alcohol and behenyl alcohol. Examples of higher fatty acid esters include sorbitan fatty acid esters. Examples of higher fatty acid amides include stearic acid amide and oleic acid amide.

The waxes can be used singly or in combination of two or more.

Examples of the resin materials include (meth)acrylic resins, vinyl resins, cellulose resins, polyesters, polyurethanes, silicone resins, and fluororesins, and various resins modified with silicone or fluorine. Examples of vinyl resins include vinyl chloride resin, vinyl acetate resin, and vinyl chloride-vinyl acetate copolymer resin.

The resin materials can be used singly or in combination of two or more.

The total content ratio of the wax and the resin material in the release layer is preferably 70 mass % or more and 100 mass % or less, more preferably 80 mass % or more and 100 mass % or less.

In one embodiment, the release layer may contain a rubber component as well as the wax and/or the resin material. This configuration can, for example, provide the release layer with elasticity to improve close contact between the transfer layer and the transfer target. Examples of the rubber component include styrene butadiene rubber, butadiene rubber, isoprene rubber, butyl rubber, and nitrile rubber.

When the release layer contains a rubber component, the content ratio of the rubber component in the release layer is preferably 5 mass % or more. The content ratio of the rubber component in the release layer is preferably 15 mass % or less.

The release layer may contain one or two or more additives. Examples of the additives include metallic soap, plasticizers, antistatic agents, ultraviolet absorbers, inorganic particles, organic particles, colorants, release agents, and dispersants.

When the release layer contains additives, the content ratio of the additives in the release layer is preferably 0.5 mass % or more. The content ratio of the additives in the release layer is preferably 2.5 mass % or less.

The thickness of the release layer is preferably 0.1 μm or more, more preferably 0.2 μm or more. The release layer with such a thickness can improve, for example, transferability and resolution. The thickness of the release layer is preferably 5.0 μm or less, more preferably 1.5 μm or less.

### <Backing Layer>

In one embodiment, the thermal transfer sheet of the present disclosure may include a backing layer on a surface of the substrate on which no transfer layer is provided. The backing layer of the thermal transfer sheet can suppress, for example, sticking and wrinkling caused by heating during thermal transfer.

In one embodiment, the backing layer contains a resin material. Examples of the resin material include silicone resins, (meth)acrylic-modified silicone resins, vinyl resins, styrene resins, (meth)acrylic resins, polyesters, polyurethanes, silicone-modified polyurethane, fluorine-modified polyurethane, and cellulose resins. The resin materials can be used singly or in combination of two or more.

In one embodiment, the backing layer may contain, as a resin material, a resin that is cured when used in combination with an isocyanate compound. Examples of such a resin include polyvinyl acetals, such as polyvinyl acetoacetal and polyvinyl butyral. The isocyanate compounds can be used singly or in combination of two or more.

The backing layer may contain one or two or more of the additives.

In one embodiment, the backing layer may contain particles, such as inorganic particles and organic particles.

Examples of inorganic particles include clay minerals, carbonates, hydroxides, sulfates, oxides, graphite, saltpeter, and boron nitride. Examples of clay minerals include talc and kaolin. Examples of carbonates include calcium carbonate and magnesium carbonate. Examples of hydroxides include aluminum hydroxide and magnesium hydroxide. Examples of sulfates include calcium sulfate. Examples of oxides include silica.

Examples of organic particles include organic resin particles made of a resin, and crosslinked-resin particles produced by reacting the resin with a crosslinking agent. Examples of the resin include (meth)acrylic resins, Teflon (registered trademark) resin, silicone resins, lauroyl resin, styrene resins, acetal resins, phenol resins, and amide resins.

One type or two or more types of particles can be used.

The backing layer preferably has a thickness of 0.1 μm or more. The backing layer with such a thickness can, for example, improve the transfer of thermal energy during thermal transfer and can also suppress sticking and wrinkling. The thickness of the backing layer is preferably 2.0 μm or less, more preferably 1.0 μm or less.

### <Transfer Target>

Examples of the transfer target include a resin film and a paper substrate.

Examples of the resin film include the resin film described above as the substrate in the thermal transfer sheet. Examples of the paper substrate include high-quality paper, plain paper, art paper, coated paper, resin-coated paper, cast-coated paper, paperboard, synthetic paper, and impregnated paper. The transfer target may be a laminate including two or more types of resin films, a laminate including two or more types of paper substrates, or a laminate including one or more types of resin films and one or more types of paper substrates.

### [Method for Producing Image-Printed Material]

A method for producing an image-printed material of the present disclosure includes:
a step of preparing the thermal transfer sheet of the present disclosure and a transfer target (preparing step); and
a step of thermally transferring the transfer layer of the thermal transfer sheet onto the transfer target (transferring step).

### <Preparing Step>

The details of the thermal transfer sheet and the transfer target are as described above.

### <Transferring Step>

The method for producing an image-printed material of the present disclosure includes a step of thermally transferring at least part of the transfer layer from the thermal transfer sheet onto the transfer target. In this step, an image composed of characters, line drawings, patterns, symbols, a combination of these, or the like can be formed on a transfer target. Examples of the image include variable information, such as addresses, customer information, numbers, and barcodes.

Specifically, the transfer layer of the thermal transfer sheet is brought into contact with the surface of the transfer target, and energy is next applied onto a desired region of the thermal transfer sheet to transfer the transfer layer in the region onto the transfer target. An image can be accordingly formed on the transfer target.

In one embodiment, the transferring step can form an image by passing the superimposed thermal transfer sheet and transfer target through between a thermal head and a platen roller in a thermal transfer printer while heating the thermal transfer sheet by the thermal head.

### [Image-Printed Material]

An image-printed material of the present disclosure includes a transfer target and a transfer layer on the transfer target. The transfer layer includes an adhesive layer. The adhesive layer contains an allyl resin and a modified olefin polymer. The adhesive layer is in contact with the transfer target.

The details of each element in the image-printed material are as described above, and the description in this section is omitted. The image-printed material of the present disclosure can be produced by, for example, the method for producing an image-printed material described above.

The present disclosure relates to, for example, the following [1] to [12].
[1] A thermal transfer sheet includes a substrate and a transfer layer on the substrate, wherein the transfer layer includes an adhesive layer, the adhesive layer forms one surface layer of the thermal transfer sheet, and the adhesive layer contains an allyl resin and a modified olefin polymer.
[2] The thermal transfer sheet according to [1], wherein the allyl resin is a diallyl phthalate resin.
[3] The thermal transfer sheet according to [1] or [2], wherein the adhesive layer further contains at least one selected from an ethylene-vinyl acetate copolymer resin and a styrene-(meth)acrylic copolymer resin.
[4] The thermal transfer sheet according to any one of [1] to [3], wherein the transfer layer further includes a colorant layer, and the colorant layer contains a colorant and a resin material.
[5] The thermal transfer sheet according to [4], wherein the resin material is an allyl resin.
[6] The thermal transfer sheet according to [4], wherein the colorant layer contains a (meth)acrylic resin and a vinyl chloride-vinyl acetate copolymer resin as the resin material.
[7] The thermal transfer sheet according to [4], wherein the colorant layer contains an allyl resin and a vinyl chloride-vinyl acetate copolymer resin as the resin material.
[8] The thermal transfer sheet according to any one of [1] to [7], wherein the transfer layer further includes a release layer, and the release layer forms a surface layer of the transfer layer adjacent to the substrate.
[9] The thermal transfer sheet according to any one of [1] to [8], wherein, in the adhesive layer, a content ratio of the allyl resin is 10 mass % or more and 95 mass % or less, and a content ratio of the modified olefin polymer is 5 mass % or more and 90 mass % or less.
[10] The thermal transfer sheet according to any one of [1] to [9], wherein, in the adhesive layer, a content ratio of the allyl resin is larger than a content ratio of the modified olefin polymer.
[11] A method for producing an image-printed material, the method including a step of preparing the thermal transfer sheet according to any one of [1] to and a transfer target, and a step of thermally transferring the transfer layer of the thermal transfer sheet onto the transfer target.
[12] An image-printed material including a transfer target and a transfer layer on the transfer target, wherein the transfer layer includes an adhesive layer in direct contact with the transfer target, and the adhesive layer contains an allyl resin and a modified olefin polymer.

### EXAMPLES

Next, the present disclosure will be described in more detail by way of Examples, but the present disclosure is not limited to these Examples. In the following description, the unit “part” means “part by mass.” The amounts in the following description and Table 1 are values based on solids content, excluding water and organic solvents.

### Example 1

A coating liquid used for a release layer and having the composition described below was applied to one surface of a polyethylene terephthalate (PET) film with a thickness of 4.5 μm and dried to form a release layer with a thickness of 0.5 μm. A coating liquid used for a colorant layer and having the composition described below was applied onto the release layer and dried to form a colorant layer with a thickness of 0.8 μm. A coating liquid used for an adhesive layer and having the composition described below was applied onto the colorant layer and dried to form an adhesive layer with a thickness of 0.25 μm. A coating liquid used for a backing layer and having the composition described below was applied to the other surface of the PET film and dried to form a backing layer with a thickness of 0.3 μm. A thermal transfer sheet was produced accordingly.

### <Coating Liquid Used for Release Layer>

Carnauba wax 10 parts
   (TRASOL O-102, Chukyo Yushi Co., Ltd.)
Styrene butadiene rubber 1 part
   (LX430, Zeon Corporation)
Water 10 parts
Isopropyl alcohol (IPA) 30 parts

### <Coating Liquid Used for Colorant Layer>

Allyl resin K 100 parts
   (DAISO DAP (registered trademark) K, Mw 25,000, softening temperature 83° C., iodine value 55 g/100 g, Osaka Soda Co., Ltd.)
Carbon black 60 parts
Methyl ethyl ketone (MEK) 300 parts

### <Coating Liquid Used for Adhesive Layer>

Acid-modified chlorinated polypropylene 30 parts
   (Superchlon (registered trademark) 3221S, Nippon Paper Industries Co., Ltd.)
Allyl resin K 70 parts
MEK 200 parts
Toluene 800 parts

### <Coating Liquid Used for Backing Layer>

Acrylic-modified silicone resin 10 parts
   (Polyalloy NSA-X55, available from Natoco Co., Ltd.)
MEK 20 parts

### Examples 2 to 22, Comparative Examples 1 to 8

Thermal transfer sheets were produced in the same manner as in Example 1 except that the types and amounts of resin materials in the adhesive layer and the colorant layer were as described in Table 1 to Table 3.

The details of each component in Table 1 to Table 3 are as described below.
Allyl resin A: DAISO DAP (registered trademark) A, Mw 55,000, softening temperature 93° C., iodine value 55 g/100 g, Osaka Soda Co., Ltd.
Styrene acrylic resin: FSR-044, Fujikura Kasei Co., Ltd.
Styrene acrylic resin: TOYO MS (registered trademark)-200,
   MFR 1.8 g/10 min, TOYO STYRENE Co., Ltd.
Acrylic resin: DIANAL (registered trademark) BR-87,
   Mw 25,000, Tg 105° C., Mitsubishi Chemical Corporation
Amorphous polyester: VYLON (registered trademark) GK250,
   Mn 10,000, Tg 60° C., TOYOBO CO., LTD.
Amorphous polyester: Elitel (registered trademark) UE3380,
   Mn 8,000, Tg 60° C., UNITIKA LTD.
Ethylene-vinyl acetate copolymer resin:
   EVAFLEX (registered trademark) EV250,
   MFR 15 g/10 min, vinyl acetate content 28 mass %,
   Dow-Mitsui Polychemicals Co., Ltd.
Vinyl chloride-vinyl acetate copolymer resin:
   SOLBIN (registered trademark) CL,
   Mn 25,000, vinyl acetate content 14 mass %,
   Tg 70° C., Nissin Chemical Co., Ltd.

### [Evaluation of Transferability (Resolution)]

The transfer layer of each of the thermal transfer sheets produced in Examples and Comparative Examples was transferred by using a printer (DataFlex 6330 available from Videojet) to form a ladder barcode image on a PET surface of a polyethylene terephthalate (PET)-linear low density polyethylene (LLDPE)-laminated film or an OPP surface of a biaxially oriented polypropylene (OPP)-cast polypropylene (CPP)-laminated film, which was a transfer target. The transfer conditions were a printing density of 80%, a printing speed of 250 mm/sec, and a pressure of 3.0 kgf/cm². The formed image was evaluated by using a barcode checker (Quick Check 850 available from Honeywell) on the basis of the following evaluation criteria.

### (Evaluation Criteria)

A: The evaluation result of the printed material determined by the barcode checker was A.
B: The evaluation result of the printed material determined by the barcode checker was B or C.
C: The evaluation result of the printed material determined by the barcode checker was D.
D: The barcode checker was unable to evaluate the printed material.

### [Evaluation of Durability]

The transfer layer of each of the thermal transfer sheets produced in Examples and Comparative Examples was transferred by using a printer (DataFlex 6330 available from Videojet) to form a picket barcode image on a PET surface of a PET-LLDPE-laminated film or an OPP surface of an OPP-CPP-laminated film, which was a transfer target. The transfer conditions were a printing density of 100%, a printing speed of 200 mm/sec, and a pressure of 3.0 kgf/cm².

### <Scratch Resistance>

The surface of the image formed as described above was subjected to 20 strokes of rubbing with a nail in an environment at 22.5° C. and a relative humidity of 40%. The image after rubbing was evaluated by using the barcode checker on the basis of the following evaluation criteria.

### (Evaluation Criteria)

A: The evaluation result determined by the barcode checker after rubbing was A.
B: The evaluation result determined by the barcode checker after rubbing was B or C.
D: The evaluation result determined by the barcode checker after rubbing was D or lower.

### <Alcohol Resistance>

The surface of the image formed as described above was subjected to 50 strokes of rubbing under a load of 200 g with a cotton cloth impregnated with 0.5 cc of isopropanol using Color Fastness Rubbing Tester (AB-301 available from Tester Sangyo Co., Ltd,) in an environment at 22.5° C. and a relative humidity of 40%. The image after rubbing was evaluated by using the barcode checker on the basis of the following evaluation criteria.

### (Evaluation Criteria)

A: The evaluation result determined by the barcode checker after rubbing was A.

B: The evaluation result determined by the barcode checker after rubbing was B or C.
D: The evaluation result determined by the barcode checker after rubbing was D or lower.

### [Evaluation of Close Contact]

The transfer layer of each of the thermal transfer sheets produced in Examples and Comparative Examples was transferred by using a printer (DataFlex 6330 available from Videojet) to form a fine text image on a PET surface of a PET-LLDPE-laminated film or an OPP surface of an OPP-CPP-laminated film, which was a transfer target. The transfer conditions were a printing density of 100%, a printing speed of 400 mm/sec, and a pressure of 3.0 kgf/cm². The surface of the image formed as described above was subjected to 3 strokes of rubbing with a cotton cloth in an environment at 22.5° C. and a relative humidity of 40%. The image after rubbing was evaluated by visual observation on the basis of the following evaluation criteria.

### (Evaluation Criteria)

A⁺: There was no dirt on the cotton cloth after rubbing.
A: There was less noticeable dirt on the cotton cloth after rubbing.
B: There was some dirt on the cotton cloth after rubbing.
C: There was deeper dirt with prominent colors on the cotton cloth after rubbing.
D: There was dirt on the cotton cloth after rubbing, and the image itself was also blurred in some cases.

### [Evaluation of Blocking]

Two thermal transfer sheets produced in Examples and Comparative Examples were superimposed on top of each other with the thermal transfer sheets in a separate sheet form and subjected to a load of 2 kgf/cm² in the lamination direction. The obtained laminate was stored under the conditions of 50° C. and 85% RH for 24 hours. The laminate after storage was evaluated for the blocking resistance of the thermal transfer sheets on the basis of the following evaluation criteria. The conditions of continuous loading were storage conditions stricter than commonly used storage conditions and were mandatory facilitating conditions.

### (Evaluation Criteria)

A: No blocking was observed.
B: Slight blocking was observed, but there is no problem in practical use.
C: Some or significant blocking was observed.

TABLE 1

| | | | Example | Example | Example | Example | Example | Example |
|---|---|---|---|---|---|---|---|---|
| | | | 1 | 2 | 3 | 4 | 5 | 6 |
| Adhesive | Acid-modified chlorinated | Superchlon | 30 | 30 | 70 | 30 | 30 | 30 |
| layer | polypropylene | 3221S | | | | | | |
| (amount) | Allyl resin K | DAISO DAP K | 70 | | 30 | 70 | 70 | 70 |
| | Allyl resin A | DAISO DAP A | | 70 | | | | |
| | Styrene acrylic resin | FSR-044 | | | | | | |
| | Amorphous polyester | VYLON GK250 | | | | | | |
| | Acrylic resin | DIANAL BR-87 | | | | | | |
| | Ethylene-vinyl acetate | EV250 | | | | | | 10 |
| | copolymer resin | | | | | | | |
| | Styrene acrylic resin | TOYO MS-200 | | | | | | 10 |
| Colorant | Allyl resin K | DAISO DAP K | 100 | 100 | 100 | | | |
| layer | Allyl resin A | DAISO DAP A | | | | 100 | | 50 |
| (amount) | Acrylic resin | DIANAL BR-87 | | | | | | |
| | Amorphous polyester | Elitel UE3380 | | | | | 100 | |
| | Amorphous polyester | VYLON GK250 | | | | | | |
| | Vinyl chloride-vinyl | SOLBIN CL | | | | | | 50 |
| | acetate copolymer resin | | | | | | | |

| | | | | | | | |
|---|---|---|---|---|---|---|---|
| Scratch | PET | A | A | B | A | A | A |
| resistance | OPP | A | A | B | A | A | A |
| (nail) | | | | | | | |
| Alcohol | PET | A | A | B | A | A | A |
| resistance | OPP | A | A | A | A | A | A |
| Resolution | PET | A | A | B | B | C | A |
| (sharpness) | OPP | A | A | A | B | C | A |
| Close | PET | D | D | D | C | D | A |
| contact | OPP | D | D | D | C | D | A |
| Blocking | | C | C | C | C | A | A |

| | | | Example | Example | Example | Example | Example |
|---|---|---|---|---|---|---|---|
| | | | 7 | 8 | 9 | 10 | 11 |
| Adhesive | Acid-modified chlorinated | Superchlon | 30 | 30 | 30 | 30 | 30 |
| layer | polypropylene | 3221S | | | | | |
| (amount) | Allyl resin K | DAISO DAP K | 70 | 70 | 70 | 70 | 70 |
| | Allyl resin A | DAISO DAP A | | | | | |
| | Styrene acrylic resin | FSR-044 | | | | | |
| | Amorphous polyester | VYLON GK250 | | | | | |
| | Acrylic resin | DIANAL BR-87 | | | | | |
| | Ethylene-vinyl acetate | EV250 | 10 | 20 | 20 | 20 | 20 |
| | copolymer resin | | | | | | |
| | Styrene acrylic resin | TOYO MS-200 | | 20 | | 20 | 20 |
| Colorant | Allyl resin K | DAISO DAP K | | | | | |
| layer | Allyl resin A | DAISO DAP A | 50 | 50 | 50 | 80 | 40 |
| (amount) | Acrylic resin | DIANAL BR-87 | | | | | |
| | Amorphous polyester | Elitel UE3380 | | | | | |
| | Amorphous polyester | VYLON GK250 | | | | | |
| | Vinyl chloride-vinyl | SOLBIN CL | 50 | 50 | 50 | 20 | 60 |
| | acetate copolymer resin | | | | | | |

| | | | | | | |
|---|---|---|---|---|---|---|
| Scratch | PET | A | A | A | A | A |
| resistance | OPP | A | A | A | A | A |
| (nail) | | | | | | |
| Alcohol | PET | A | A | A | A | A |
| resistance | OPP | A | A | A | A | A |
| Resolution | PET | A | A | A | A | A |
| (sharpness) | OPP | A | A | A | A | A |
| Close | PET | A | A+ | A+ | A+ | A+ |
| contact | OPP | A | A+ | A+ | A+ | A+ |
| Blocking | | B | A | B | B | A |

TABLE 2

| | | | Example | Example | Example | Example | Example | Example |
|---|---|---|---|---|---|---|---|---|
| | | | 12 | 13 | 14 | 15 | 16 | 17 |
| Adhesive | Acid-modified chlorinated | Superchlon | 30 | 30 | 30 | 30 | 30 | 30 |
| layer | polypropylene | 3221S | | | | | | |
| (amount) | Allyl resin K | DAISO DAP K | 70 | 70 | 70 | 70 | 70 | 70 |
| | Allyl resin A | DAISO DAP A | | | | | | |
| | Styrene acrylic resin | FSR-044 | | | | | | |
| | Amorphous polyester | VYLON GK250 | | | | | | |
| | Acrylic resin | DIANAL BR-87 | | | | | | |
| | Ethylene-vinyl acetate | EV250 | 20 | 20 | 20 | 20 | 10 | |
| | copolymer resin | | | | | | | |
| | Styrene acrylic resin | TOYO MS-200 | 20 | 20 | 20 | 20 | | 10 |
| Colorant | Allyl resin K | DAISO DAP K | | | | 50 | 100 | 100 |
| layer | Allyl resin A | DAISO DAP A | 30 | 20 | 10 | | | |
| (amount) | Acrylic resin | DIANAL BR-87 | | | | | | |
| | Amorphous polyester | Elitel UE3380 | | | | | | |
| | Amorphous polyester | VYLON GK250 | | | | | | |
| | Vinyl chloride-vinyl | SOLBIN CL | 70 | 80 | 90 | 50 | | |
| | acetate copolymer resin | | | | | | | |

| | | | | | | | |
|---|---|---|---|---|---|---|---|
| Scratch | PET | A | A | B | A | A | A |
| resistance | OPP | A | A | B | A | A | A |
| (nail) | | | | | | | |
| Alcohol | PET | A | A | B | A | A | A |
| resistance | OPP | A | A | B | A | A | A |
| Resolution | PET | B | B | C | A | A | B |
| (sharpness) | OPP | B | B | C | A | A | B |
| Close | PET | A+ | A+ | A+ | A+ | A | D |
| contact | OPP | A+ | A+ | A+ | A+ | A | D |
| Blocking | | A | A | A | A | C | C |

| | | | Example | Example | Example | Example | Example |
|---|---|---|---|---|---|---|---|
| | | | 18 | 19 | 20 | 21 | 22 |
| Adhesive | Acid-modified chlorinated | Superchlon | 30 | 30 | 30 | 30 | 30 |
| layer | polypropylene | 3221S | | | | | |
| (amount) | Allyl resin K | DAISO DAP K | 70 | 70 | 70 | 70 | 70 |
| | Allyl resin A | DAISO DAP A | | | | | |
| | Styrene acrylic resin | FSR-044 | | | | | |
| | Amorphous polyester | VYLON GK250 | | | | | |
| | Acrylic resin | DIANAL BR-87 | | | | | |
| | Ethylene-vinyl acetate | EV250 | 10 | 20 | 20 | 20 | 20 |
| | copolymer resin | | | | | | |
| | Styrene acrylic resin | TOYO MS-200 | 10 | 20 | 20 | 20 | 20 |
| Colorant | Allyl resin K | DAISO DAP K | 100 | 100 | | | |
| layer | Allyl resin A | DAISO DAP A | | | 100 | | |
| (amount) | Acrylic resin | DIANAL BR-87 | | | | 50 | |
| | Amorphous polyester | Elitel UE3380 | | | | | 80 |
| | Amorphous polyester | VYLON GK250 | | | | | |
| | Vinyl chloride-vinyl | SOLBIN CL | | | | 50 | 20 |
| | acetate copolymer resin | | | | | | |

| | | | | | | |
|---|---|---|---|---|---|---|
| Scratch | PET | A | A | A | A | B |
| resistance | OPP | A | A | A | A | B |
| (nail) | | | | | | |
| Alcohol | PET | A | A | A | A | B |
| resistance | OPP | A | A | A | A | B |
| Resolution | PET | A | A | A | A | A |
| (sharpness) | OPP | A | A | A | A | A |
| Close | PET | A | A+ | A+ | A+ | A+ |
| contact | OPP | A | A+ | A+ | A+ | A+ |
| Blocking | | C | C | C | A | A |

TABLE 3

| | | | Compar- | Compar- | Compar- | Compar- | Compar- | Compar- | Compar- | Compar- |
|---|---|---|---|---|---|---|---|---|---|---|
| | | | ative | ative | ative | ative | ative | ative | ative | ative |
| | | | Exam- | Exam- | Exam- | Exam- | Exam- | Exam- | Exam- | Exam- |
| | | | ple 1 | ple 2 | ple 3 | ple 4 | ple 5 | ple 6 | ple 7 | ple 8 |
| Adhesive | Acid-modified | Superchlon | 30 | 30 | 30 | 30 | 100 | | 30 | 30 |
| layer | chlorinated | | | | | | | | | |
| (amount) | polypropylene | 3221S | | | | | | | | |
| | Allyl resin K | DAISO DAP K | | | | | | 100 | | |
| | Allyl resin A | DAISO DAP A | | | | | | | | |
| | Styrene acrylic | FSR-044 | | | | 70 | | | | |
| | resin | | | | | | | | | |
| | Amorphous | VYLON GK250 | 70 | | 35 | | | | 70 | 70 |
| | polyester | | | | | | | | | |
| | Acrylic resin | DIANAL BR-87 | | 70 | 35 | | | | | |
| | Ethylene-vinyl | EV250 | | | | | | | 10 | 10 |
| | acetate | | | | | | | | | |
| | copolymer resin | | | | | | | | | |
| | Styrene acrylic | TOYO MS-200 | | | | | | | 10 | 10 |
| | resin | | | | | | | | | |
| Colorant | Allyl resin K | DAISO DAP K | 100 | 100 | 100 | 100 | 100 | 100 | | |
| layer | Allyl resin A | DAISO DAP A | | | | | | | 50 | |
| (amount) | Acrylic resin | DIANAL BR-87 | | | | | | | | |
| | Amorphous | Elitel UE3380 | | | | | | | | |
| | polyester | | | | | | | | | |
| | Amorphous | VYLON GK250 | | | | | | | | |
| | polyester | | | | | | | | | |
| | Vinyl chloride- | SOLBIN CL | | | | | | | 50 | 100 |
| | vinyl acetate | | | | | | | | | |
| | copolymer resin | | | | | | | | | |

| | | | | | | | | | |
|---|---|---|---|---|---|---|---|---|---|
| Scratch | PET | A | D | B | D | D | A | A | B |
| resistance | OPP | A | D | B | D | D | D | A | B |
| (nail) | | | | | | | | | |
| Alcohol | PET | A | D | D | B | D | A | A | B |
| resistance | OPP | A | D | D | B | A | D | A | B |
| Resolution | PET | D | D | B | A | B | A | D | D |
| (sharpness) | OPP | D | B | A | A | A | D | D | D |
| Close | PET | D | D | C | A | D | D | D | A |
| contact | OPP | D | C | C | A | D | D | D | A |
| Blocking | | C | C | C | C | C | C | A | A |

It should be understood by those skilled in the art that the thermal transfer sheet and the like of the present disclosure are not limited by the description of Examples above, and the above Examples and specification are merely for illustrating the principle of the present disclosure, and various modifications or improvements can be made without departing from the spirit and scope of the present disclosure, and all of these modifications or improvements are included in the scope of the present disclosure as claimed. Furthermore, the scope claimed by the present disclosure includes not only the scope of the claims but also equivalents thereof.

### REFERENCE SIGNS LIST

1: thermal transfer sheet
10: substrate
20: transfer layer
22: adhesive layer
24: colorant layer
26: release layer
30: backing layer

1. A thermal transfer sheet comprising a substrate and a transfer layer on the substrate,
wherein the transfer layer includes an adhesive layer,
the adhesive layer forms one surface layer of the thermal transfer sheet, and
the adhesive layer contains an allyl resin and a modified olefin polymer.

2. The thermal transfer sheet according to claim 1, wherein the allyl resin is a diallyl phthalate resin.

3. The thermal transfer sheet according to claim 1, wherein the adhesive layer further contains at least one selected from an ethylene-vinyl acetate copolymer resin and a styrene-(meth)acrylic copolymer resin.

4. The thermal transfer sheet according to claim 1,
wherein the transfer layer further includes a colorant layer, and
the colorant layer contains a colorant and a resin material.

5. The thermal transfer sheet according to claim 4, wherein the resin material is an allyl resin.

6. The thermal transfer sheet according to claim 4, wherein the colorant layer contains a (meth)acrylic resin and a vinyl chloride-vinyl acetate copolymer resin as the resin material.

7. The thermal transfer sheet according to claim 4, wherein the colorant layer contains an allyl resin and a vinyl chloride-vinyl acetate copolymer resin as the resin material.

8. The thermal transfer sheet according to claim 1,
wherein the transfer layer further includes a release layer, and
the release layer forms a surface layer of the transfer layer adjacent to the substrate.

9. The thermal transfer sheet according to claim 1, wherein, in the adhesive layer, a content ratio of the allyl resin is 10 mass % or more and 95 mass % or less, and a content ratio of the modified olefin polymer is 5 mass % or more and 90 mass % or less.

10. The thermal transfer sheet according to claim 1, wherein, in the adhesive layer, a content ratio of the allyl resin is larger than a content ratio of the modified olefin polymer.

11. A method for producing an image-printed material, the method comprising:
a step of preparing a thermal transfer sheet and a transfer target, wherein the thermal transfer sheet includes a substrate and a transfer layer on the substrate, the transfer layer includes an adhesive layer, the adhesive layer forms one surface layer of the thermal transfer sheet, and the adhesive layer contains an allyl resin and a modified olefin polymer; and
a step of thermally transferring the transfer layer of the thermal transfer sheet onto the transfer target.

12. An image-printed material comprising a transfer target and a transfer layer on the transfer target,
wherein the transfer layer includes an adhesive layer in direct contact with the transfer target, and
the adhesive layer contains an allyl resin and a modified olefin polymer.

13. The thermal transfer sheet according to claim 2, wherein the adhesive layer further contains at least one selected from an ethylene-vinyl acetate copolymer resin and a styrene-(meth)acrylic copolymer resin.

14. The thermal transfer sheet according to claim 2,
wherein the transfer layer further includes a colorant layer, and
the colorant layer contains a colorant and a resin material.

15. The thermal transfer sheet according to claim 2,
wherein the transfer layer further includes a release layer, and
the release layer forms a surface layer of the transfer layer adjacent to the substrate.

16. The thermal transfer sheet according to claim 2, wherein, in the adhesive layer, a content ratio of the allyl resin is 10 mass % or more and 95 mass % or less, and a content ratio of the modified olefin polymer is 5 mass % or more and 90 mass % or less.

17. The thermal transfer sheet according to claim 2, wherein, in the adhesive layer, a content ratio of the allyl resin is larger than a content ratio of the modified olefin polymer.
